(19) United States
(12) Patent Application Publication
(10) Pub. No.: US 2023/0254105 A1
(43) Pub. Date: Aug. 10, 2023

(54) METHODS, COMMUNICATIONS DEVICES AND INFRASTRUCTURE EQUIPMENT

(71) Applicant: Sony Group Corporation, Tokyo (JP)

(72) Inventors: Shin Horng WONG, Basingstoke (GB); Martin Warwick BEALE, Basingstoke (GB); Kazuyuki SHIMEZAWA, Basingstoke (GB)

(73) Assignee: Sony Group Corporation, Tokyo (JP)

(21) Appl. No.: 18/012,655

(22) PCT Filed: Jul. 22, 2021
(86) PCT No.: PCT/EP2021/070618

§ 371 Date: Dec. 23, 2022

(30) Foreign Application Priority Data
Jul. 24, 2020 (EP) 20187776.8

(51) Int. Cl. H04L 5/16; H04W 72/20; H04L 5/00

(52) U.S. Cl. CPC H04L 5/16; H04W 72/20; H04L 5/0053

(57) ABSTRACT

A method of operating a device in a wireless network is provided. The device operates in accordance with a Half Duplex Frequency Division Duplex, HD-FDD, mode of operation. The method comprises determining that the device is to transmit an uplink signal to the wireless network in a set of uplink resources, determining that the device is to receive a downlink control signal in a set of downlink resources, determining that the set of uplink resources at least partially overlaps in time with the set of downlink resources, and, depending on a characteristic of the uplink signal and/or a characteristic of the downlink signal, either transmitting the uplink signal in the set of uplink resources and not receiving the downlink signal in the set of downlink resources, or receiving the downlink signal in the set of downlink resources and not transmitting the uplink signal in the set of uplink resources.

### BACKGROUND

### Field of Disclosure

The present disclosure relates to communications devices, infrastructure equipment and methods for the transmission and reception of data by a communications device in a wireless communications network.

The present application claims the Paris Convention priority from European patent application number EP20187776.8, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever increasing range of devices associated with a wider range of data traffic profiles and types than existing systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different considerations may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device in a wireless communications network. The communications device operates in accordance with a Half Duplex Frequency Division Duplex, HD-FDD, mode of operation. The method comprises determining that the communications device is to transmit an uplink signal comprising at least one of data and control information to the wireless communications network in a set of uplink resources of a wireless access interface, determining that the communications device is to receive a downlink control signal from the wireless communications network in a set of downlink resources of the wireless access interface, determining that the set of uplink resources at least partially overlaps in time with the set of downlink resources, and, depending on a characteristic of the uplink signal and/or a characteristic of the downlink signal, either transmitting the uplink signal in the set of uplink resources and not receiving the downlink signal in the set of downlink resources, or receiving the downlink signal in the set of downlink resources and not transmitting the uplink signal in the set of uplink resources.

Embodiments of the present technique, which, in addition to methods of operating communications devices, relate to methods of operating infrastructure equipment, communications devices and infrastructure equipment, and circuitry for communications devices and infrastructure equipment, allow for more efficient use of radio resources by an HD-FDD communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 shows an example of an uplink transmission colliding with an uplink cancellation indicator (UL CI) for a half duplex frequency division duplexing (HD-FDD) UE in accordance with certain embodiments of the present disclosure;

FIG. 5 is a part-schematic, part-message flow diagram representation of a wireless communications system in accordance with embodiments of the present technique;

FIG. 6 illustrates how an HD-FDD UE may have a high layer 1 (L1) priority Physical Uplink Shared Channel (PUSCH) overlapping a UL CI in accordance with embodiments of the present technique;

FIG. 7 illustrates how an HD-FDD UE may have a PUSCH outside of a Reference Uplink Region (RUR) of an UL CI in accordance with embodiments of the present technique;

FIG. 8 illustrates how measurement gaps may be inserted into an uplink signal to be transmitted by an HD-FDD UE that collides with a downlink control signal comprising measurement reference signals in accordance with embodiments of the present technique;

FIG. 9 illustrates how an HD-FDD UE may postpone a Physical Uplink Control Channel (PUCCH) when its transmission collides with a downlink control signal in accordance with embodiments of the present technique; and

FIG. 10 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

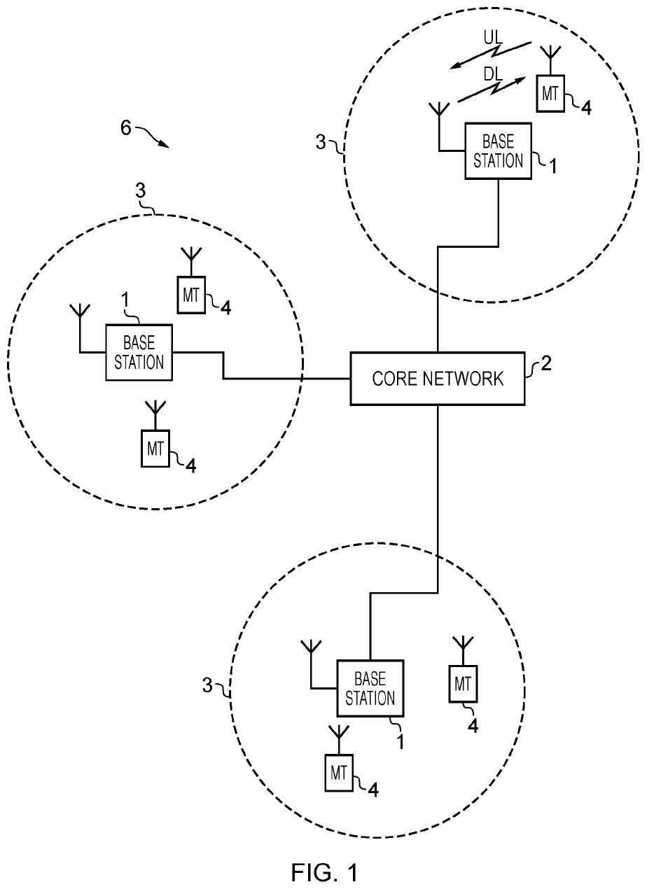

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink Data is transmitted from communications devices 4 to the base stations 1 via a radio uplink The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

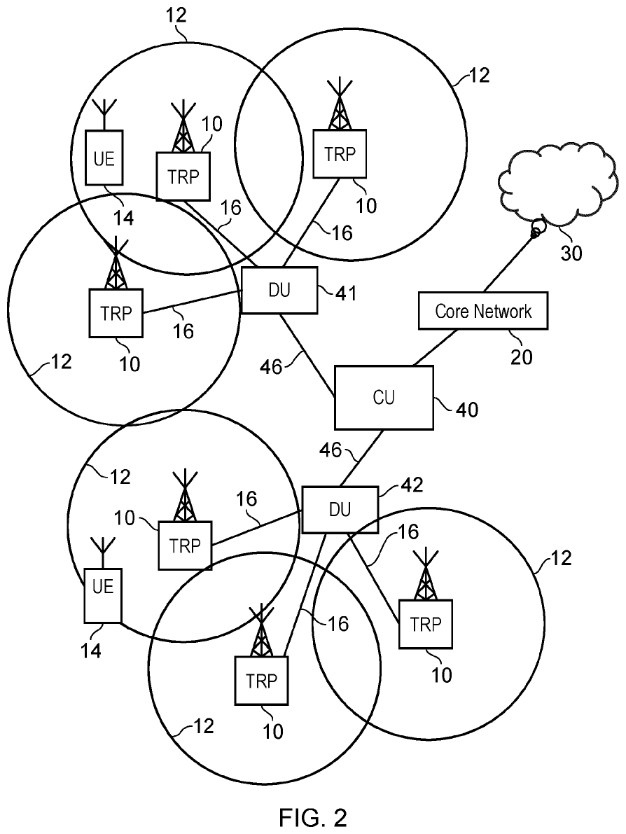

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

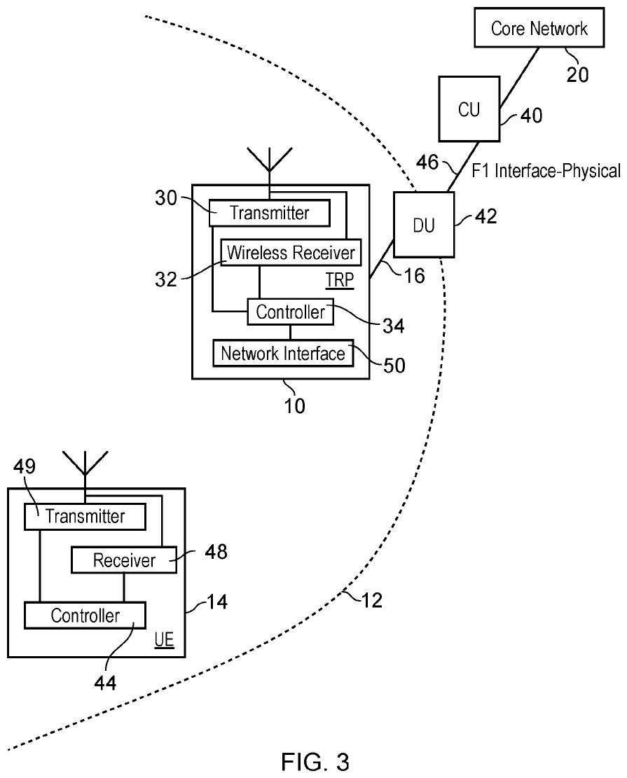

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### 5G and Reduced Capability NR Devices

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for a 32 byte packet to be transmitted from the radio protocol layer 2/3 SDU ingress point to the radio protocol layer 2/3 SDU egress point of the radio interface within 1 ms with a reliability of 99.999% to 99.9999% [2]. Enhanced Machine Type Communications (eMTC), Narrowband Internet of Things (NB-IoT) and Massive Machine Type Communications (mMTC) are other examples of reduced-capability services which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Recently, a study on Reduced Capability NR Devices has been proposed [3] with a goal to identify potential UE complexity reduction methods for use cases like industrial wireless sensors, video surveillance & wearables. The Reduced Capability (RedCap) UE is expected to have a complexity and cost that is between that of an eMTC/NB-IoT UE and a URLLC/eMBB UE. The potential UE complexity reduction features considered, with respect to a higher-capability UE, include:
Reduced number of UE receive/transmit antennas;
UE bandwidth reduction;
Half Duplex Frequency Division Duplexing (HD-FDD) operation;
Relaxed UE processing time; and
Relaxed UE processing capability.

### HD-FDD

Duplex communications refers to the ability of a device to both transmit and receive data. For example, a communications device (such as the communications device 14 of FIG. 3) may communicate in a duplex manner with the infrastructure equipment 10 by transmitting signals to the infrastructure equipment 10 and by receiving signals transmitted by the infrastructure equipment 10.

Frequency Division Duplexing (FDD) is a known technique to allow duplex communication, whereby transmissions by a communications device use communication resources at a first frequency, and transmissions to the communications device (which are received by the communications device) use communication resources at a second frequency. The transmission and reception frequencies are separated by a frequency offset. In a wireless communication network where FDD is used for communications between an infrastructure equipment and a communications device, downlink and uplink communications occur at different frequencies. This is in contrast to Time Division Duplexing (TDD) whereby uplink and downlink communications occur at different times (but may occur at the same carrier frequency).

Duplex communications can either be full duplex (FD) or half-duplex (HD). Where transmission and reception for a device occurs simultaneously (i.e. overlapping in time), this is referred to as full duplex communications. In half-duplex communications, transmission and reception do not overlap in time. It will be readily appreciated that the complexity of a communications device which is required to perform only half duplex communication (and is not required to be capable of full duplex communication) may be reduced, compared with one which is required to be capable of transmitting and receiving signals simultaneously in accordance with full duplex communication. Accordingly, there is an interest in providing for half-duplex communication, in order to permit a reduced complexity of the communication device.

In accordance with some embodiments of the present technique as described herein, FDD may be implemented in a communications device which is capable of half duplex communications and which is not capable of full-duplex communications. Such a communications device may be referred to as a Half Duplex Frequency Division Duplexing (HD-FDD) device. In HD-FDD, the communications device may be able to switch between transmission and reception independently of other communications devices in the same cell. A communications device which is not required to be capable of full duplex communication may realise a reduction in hardware complexity by, for example, not requiring a duplex filter, and/or reducing a number of oscillators, such that a single oscillator may be used for both transmission and reception. Accordingly (or for any other reason) there may be a minimum time period, which may correspond to or comprise an oscillator frequency switching time period, between operation at a first frequency (e.g. for transmission) and operation at a second frequency (e.g. for reception).

It is expected that an FDD network would share some downlink (DL) control signals, such as uplink (UL) Cancellation Indicators (CIs) and Slot Format Indicators (SFIs) between FD-FDD UEs and HD-FDD UEs. An FD-FDD UE is expected to monitor DL control signals whilst it is transmitting in the UL, but this is not possible for HD-FDD UEs. As those skilled in the art would appreciate, an UL CI, which is described in greater detail in co-pending European patent application number EP20167632.7 [4] (the contents of which are hereby incorporated by reference), may indicate that some communication resources which have previously been indicated as allocated as part of a particular first resource allocation have, subsequent to the first resource allocation, been allocated as part of a later second resource allocation. The first resource allocation may have been speculative; that is, may have been made by a gNB without having determined that the beneficiary UE of the first resource allocation has data to transmit using the allocated resources, or is otherwise able to make use of the allocated resources. For example, the first resource allocation may be a part of a periodic grant of resources, such as by means of a configured grant.

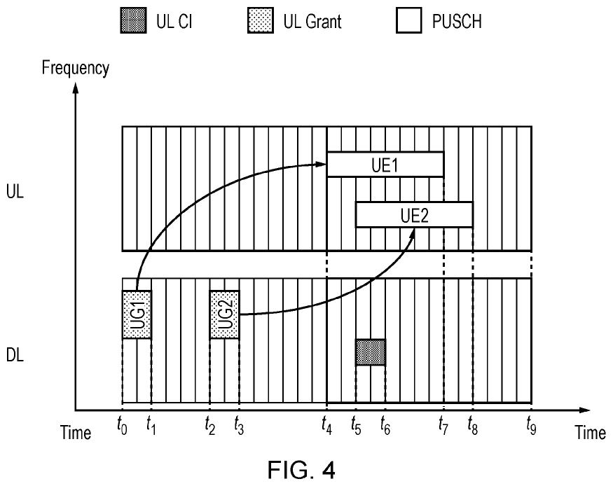

An example of overlap between UL unicast transmission and DL control signal monitoring is shown in FIG. 4, where the DL control signal is an UL CI which is transmitted by a Group Common DCI. In this example, UL grants UG1 and UG2 schedule PUSCHs for UE1 and UE2 respectively. UE1 is an FD-FDD UE, whilst UE2 is an HD-FDD UE. An UL CI, which is transmitted to a group of UEs—in this case UE1 and UE2—collides with the PUSCHs scheduled for each of UE1 and UE2. UE1 is able to read the UL CI and transmit the PUSCH without an issue. However, UE2, being HD-FDD, is unable to transmit and receive at the same time. A UL CI may be transmitted for a group of UEs to indicate whether they should cancel their UL transmissions, and typically only a subset of the UEs' transmissions are cancelled. If the UL CI is not transmitted, or does not indicate anything for UE2, then UE2 switching to the DL would lead to unnecessary disruption in its UL transmission. On the other hand, if the UL CI does target UE2, and if UE2 does not switch to DL to read the UL CI, then it will miss the cancellation indication.

Embodiments of the present disclosure provide solutions with respect to the behaviour of an HD-FDD UE when its uplink transmission collides with a downlink control signal.

Collision of Uplink Transmissions with Downlink Control Signalling in HD-FDD

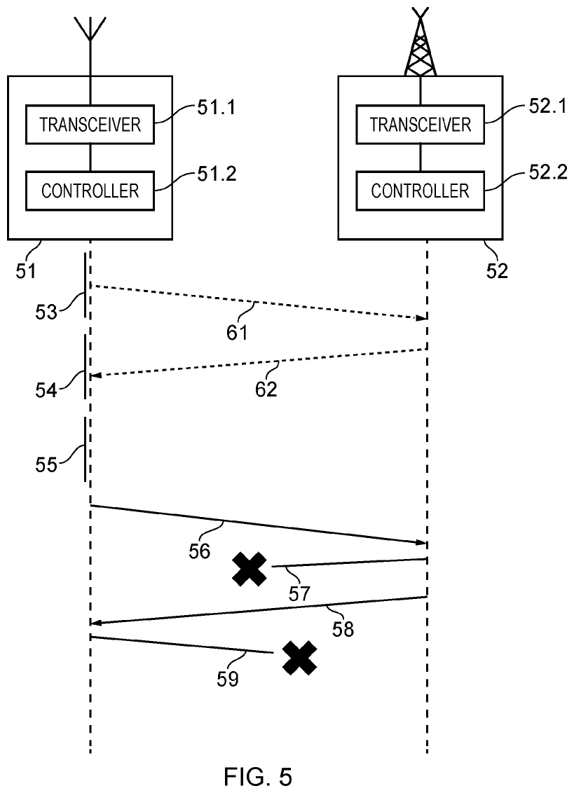

FIG. 5 shows a part schematic, part message flow diagram representation of a wireless communications system comprising a communications device 51 and an infrastructure equipment 52 forming part of a wireless communications network in accordance with at least some embodiments of the present technique. The communications device 51, which operates in accordance with a Half Duplex Frequency Division Duplex (HD-FDD) mode of operation, is configured to transmit data to or receive data from the wireless communications network, for example, to and from the infrastructure equipment 52, via a wireless access interface provided by the wireless communications network. The communications device 51 and the infrastructure equipment 52 each comprise a transceiver (or transceiver circuitry) 51.1, 52.1, and a controller (or controller circuitry) 51.2, 52.2. Each of the controllers 51.2, 52.2 may be, for example, a microprocessor, a CPU, or a dedicated chipset, etc. Each of the transceivers 51.1, 51.2 may be an integrated unit comprising elements which are configured to either transmit or to receive signals via one or more antennas, or may instead be formed of separate transmitters and receivers configured to transmit/receive signals via the (separate or shared) antennas.

As shown in the example of FIG. 5, the transceiver circuitry 51.1 and the controller circuitry 51.2 of the communications device 51 are configured in combination, to determine 53 that the communications device 51 is to transmit 61 an uplink signal comprising at least one of data and control information to the wireless communications network (e.g. to the infrastructure equipment 52) in a set of uplink resources of a wireless access interface (which may be provided by the infrastructure equipment 52), to determine 54 that the communications device is to receive 62 a downlink control signal from the wireless communications network (e.g. from the infrastructure equipment 52) in a set of downlink resources of the wireless access interface, to determine 55 that the set of uplink resources at least partially overlaps in time with the set of downlink resources, and, depending on a characteristic of the uplink signal and/or a characteristic of the downlink signal, either to transmit 56 the uplink signal in the set of uplink resources and to not receive 57 the downlink signal in the set of downlink resources, or to receive 58 the downlink signal in the set of downlink resources and to not transmit 59 the uplink signal in the set of uplink resources.

It should be appreciated by those skilled in the art that, the uplink signal may be either a Physical Uplink Control Channel (PUCCH) carrying control information or may be a Physical Uplink Shared Channel (PUSCH) carrying data information, data information and control information, or, in some cases, only control information; e.g. Channel State Information (CSI).

Essentially, embodiments of the present technique propose that when an UL transmission of an HD-FDD UE collides with a DL control signal, whether or not the UE needs to switch to the DL to monitor or decode the DL control signal depends on the type or some other characteristic of one or both of the UL transmission and the DL control signal. Embodiments of the present disclosure presented below provide solutions for various different types of UL/DL transmission.

In Rel-16 eURLLC, a layer 1 (L1)—i.e. physical layer—priority indicator was introduced for UL transmissions (PUCCH & PUSCH) to handle intra-UE prioritisation, where an UL transmission can be indicated as having either High L1 priority (for example, an eURLLC transmission) or Low L1 priority (for example, an eMBB transmission). When two UL transmissions belonging to the same UE collide in time, the UE will drop the UL transmission with the lower L1 priority. If both UL transmissions have the same L1 priority, then the UE reuses Rel-15 procedures; for example, the uplink control information (UCI) that was to be carried by a PUCCH is multiplexed onto a PUSCH that collides with the PUCCH. In Rel-16 eURLLC, the gNB indicates the L1 priority to the UE in the 1 bit “Priority indicator” DCI field, where “0” indicates Low L1 Priority and “1” indicates High L1 Priority and:
For a PUSCH, the L1 priority is indicated in the UL Grant carried by DCI Format 0_1 and 0_2; or
For a PUCCH carrying HARQ-ACK feedback for PDSCH, the L1 priority is indicated in the DL

Grant scheduling a PDSCH, carried by DCI Format 1_1 and 1_2.

As described above, a UL Cancellation Indicator (UL CI) is transmitted in a Group Common DCI (specifically a Group Common DCI Format 2_4,) which is monitored by a group of UEs. Based on the UL CI, UEs with UL transmissions (e.g. PUSCH) that overlap with indicated regions within a Reference Uplink Region (RUR) defined by the UL CI will cancel their UL transmissions. A UE supporting L1 priority can be RRC configured with one of the following two types of behaviour:
Behaviour 1: UL CI is only applicable to Low L1 priority UL transmissions; or
Behaviour 2: UL CI is applicable to all UL transmissions regardless of their L1 priority.

In an arrangement of embodiments of the present disclosure, for an HD-FDD UE with an UL transmission colliding with an UL CI monitoring period, the UE does not need to switch to the DL to monitor the UL CI if the following conditions are all met:
The UE has an UL transmission that overlaps the RUR of that UL CI (it should be noted here that the UL transmission colliding with the UL CI and the UL transmission that overlaps the RUR can be the same or different transmissions); and
The UL transmission that overlaps the RUR has High L1 priority; and
The UE is configured to only obey UL CI for Low L1 priority UL transmissions (i.e. Behaviour 1).

That is, the downlink signal is an uplink cancellation indicator, UL-CI, the UL-CI indicating a reference uplink region, RUR, defining uplink resources of the wireless access interface which have been allocated for the transmission of at least a second uplink signal by a second communications device, and the characteristic of the uplink signal overlapping the UL-CI or another uplink signal that may or may not overlap with the UL-CI of the same communications device is a priority level of a plurality of priority levels associated with the uplink signal and/or the characteristic of the uplink signal is whether or not the set of uplink resources at least partially overlaps in both time and frequency with the uplink resources defined by the RUR. As those skilled in the art would appreciate, the RUR consists of a set of resources divided into regions that is associated with a UL-CI, where the UL-CI can indicate a second set of uplink resources within this RUR. If so indicated by the UL-CI (i.e. the UL-CI indicates that overlapping transmissions need to be cancelled), the communications device configured to monitor the UL CI cancels any scheduled uplink transmission which overlaps with indicated regions in the second set of uplink resources (depending on the cancellation behaviour described previously). In at least some implementations of embodiments of the present disclosure, the communications device may always be configured to ignore the downlink control signal and transmit the uplink signal if the uplink signal has High L1 priority.

Otherwise (e.g. the UE is configured to operate in accordance with Behaviour 2, or has been scheduled a Low L1 priority UL transmission), the UE switches to the DL and monitors the UL CI. This recognises that since a Behaviour 1 UE does not need to cancel its High L1 priority UL transmission, there is no need for it to monitor the UL CI as its indication will not be applicable to it; it will be applicable instead to other UEs with Low L1 priority UL transmissions scheduled in the same resources.

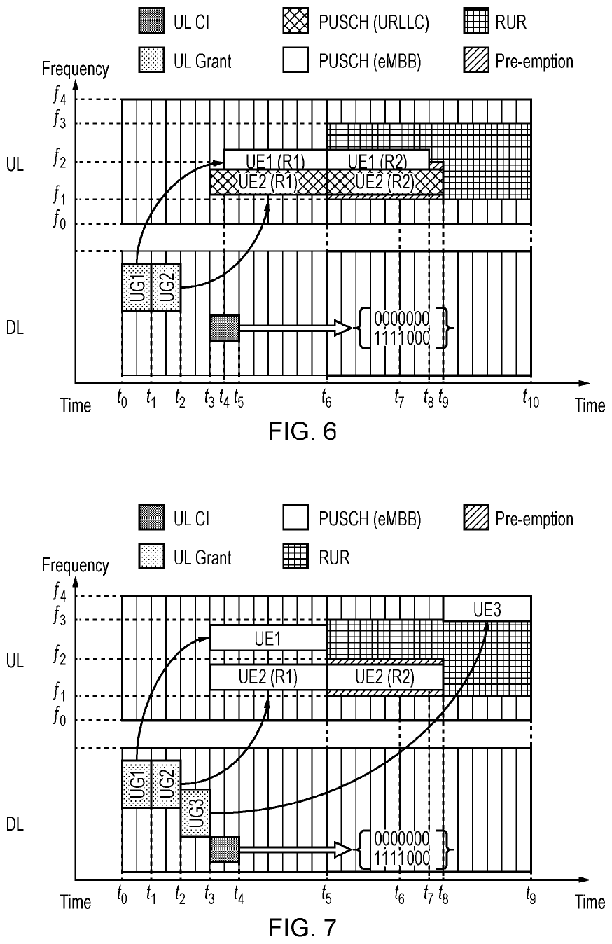

An example of this is shown in FIG. 6, where UE1 & UE2 are each HD-FDD UEs and are configured to operate in accordance with Behaviour 1. At time t₀, UE1 receives an UL Grant UG1 which schedules a Low L1 priority Type B PUSCH with 2× repetitions (labelled as R1 & R2) between time t₄ to t₈, which overlaps with UL CI at time t₄ to t₅. At time t₁, UE2 receives an UL Grant UG2 which schedules a High L1 priority Type B PUSCH with 2× repetitions (labelled as R1 & R2) between time t₃ to t₉, which overlaps during time t₄ to t₅ with UL CI which spans time t₃ to t₅. Both UE1 and UE2's UL transmissions, i.e. the 2^{nd} PUSCH repetition, fall within the RUR of the UL CI. Since UE1's UL transmission is Low L1 priority, it has to monitor the UL CI for possible cancellation and switches to the DL to monitor the UL CI. However, UE2' s UL transmission is High L1 priority and, as per this arrangement, it does not need to switch to the DL but instead transmits its PUSCH repetitions. The 2^{nd} PUSCH repetition of UE1 overlaps with regions indicated by the UL CI, and so UE1 cancels its 2^{nd} PUSCH transmission. It should be noted that if UE2 is configured with Behaviour 2, it will switch to the DL to monitor the UL CI regardless of the L1 priority of its PUSCH.

In another arrangement of embodiments of the present disclosure, if the UE is not scheduled with an UL transmission that overlaps the RUR of the UL CI, the UE can ignore the UL CI and does not need to switch to the downlink and monitor the UL CI. This recognises that the UL CI is applicable only to resources within the RUR and so if nothing is scheduled in the resources that the RUR refers to, the UL CI is not applicable to the UE and the UE can hence ignore the UL CI.

An example of this is shown in FIG. 7, where UG1 and UG2 are UL Grants scheduling Low L1 priority PUSCH for UE1 and UE2 respectively. At time t₃, the gNB transmits an UL CI with an associated RUR between time t₅ to t₉ and frequency f₁ to f₃. In this example UE1's PUSCH does not fall into the RUR, and so UE1 does not need to switch to the DL to monitor the UL CI. However, UE2's PUSCH (2^{nd} repetition) falls within the RUR and so it needs to switch to the DL to monitor the UL CI. It should be noted that the PUSCH can overlap in time with the RUR but not in frequency and so in this case the PUSCH is not within the RUR as shown in FIG. 7, where UE3's PUSCH scheduled between time t₈ & t₉ and frequency f₃ & f₄ is outside the UL CI's RUR.

Slot Format Indicators (SFIs) are transmitted using Group Common DCI (specifically a Group Common DCI Format 2_0) and are used to indicate the slot format, i.e. which symbols in the slot are DL, UL or Flexible, for a TDD system. In Rel-16 eURLLC, an enhanced Type B PUSCH is introduced which can be scheduled dynamically with repetitions and can cross a slot boundary. This is in contrast to a (non-enhanced) Type B PUSCH, which also can have variable length and start at any position within a slot unlike a Type A PUSCH, but cannot cross the slot boundary. For an enhanced Type B PUSCH that is dynamically scheduled via a dynamic grant (DG-PUSCH), i.e. PUSCH scheduled by an UL Grant, the UE ignores the SFI since the SFI may not have the same reliability as the PDCCH carrying the UL Grant for URLLC PUSCH and so the SFI is not sufficiently reliable for URLLC PUSCH. Those skilled in the art would appreciate that, although SFIs are typically used in TDD operation, they may also be used in HD-FDD operation.

In an arrangement of embodiments of the present disclosure, if an HD-FDD UE is dynamically scheduled with a Rel-16 enhanced Type B PUSCH that overlaps with an SFI, the UE does not need to switch to the DL to monitor the SFI. In other words, the downlink signal is a slot format indicator, SFI, defining a format for one or more symbols (e.g. Orthogonal Frequency Division Multiplexing (OFDM) or Single-Carrier Frequency Division Multiple Access (SC-FDMA) symbols) of a slot of the wireless communications interface, and the characteristic of the uplink signal is whether or not the uplink signal is an enhanced Type B Physical Uplink Shared Channel, PUSCH, scheduled dynamically by the wireless communications network.

In another arrangement of embodiments of the present disclosure, the UE is configured with two types of CORESET (control resource set) or SS (search space) for PDCCH monitoring. In the following paragraphs, we refer to these two types as “Type X” and “Type Y”.
In the case of the type X CORESET/SS, the UE does not need to monitor any PDCCHs in the type X CORESET/SS when the UE transmits an UL overlapping with the type X CORESET/SS in the time domain; while
In the case of the type Y CORESET/SS, the UE needs to cancel any scheduled UL signal/channel to monitor PDCCH in the type Y CORESET/SS when the UE is scheduled to transmit an UL overlapping with the type Y CORESET/SS in the time domain;
   For example, the type Y CORESET/SS can be used for a PDCCH containing UL CI and SFI;
   In some implementations of this arrangement, it may be specified that such an UL signal/channel is not scheduled during the time to monitor PDCCH in the type Y CORESET/SS. Therefore, upon detecting that the UL signal/channel at least partially overlaps in time with the set of downlink resources (i.e. the type Y CORESET/SS), the UE may determine that the scheduling of this uplink signal/channel must have been invalid, and so ignores it and monitors for PDCCHs in the type Y CORESET/SS.

Those skilled in the art will appreciate that “type X” and “type Y” as used herein are merely designations to indicate how a UE may behave differently for different types of CORESET/SS. The actual characteristics of the CORESET/SS of such types may be in accordance with well-known characteristics and types in the art, and are not limited in such a manner as described above. For example, a type Y CORESET/SS may not necessarily be used for UL CI or SFI transmission (and may be known by any other suitable name or type other than “type Y”).

In other words, the set of downlink resources is one of a control resource set, CORESET, and a search space, SS, in which the communications device is configured to receive control information from the wireless communications network, and the characteristic of the downlink signal is which type of a plurality of types the CORESET and/or SS is.

In another arrangement of embodiments of the present disclosure, indication to the UE of whether the CORESET/SS is type X or type Y may be:
Explicitly indicated by RRC signaling for each CORESET/SS; or
Implicitly indicated by RNTI (Radio Network Temporary Identifier) or any other identifier to be used for PDCCH monitoring. For example, when CI-RNTI (which is the RNTI for UL CI) or SFI-RNTI (which is the RNTI for SFI) is configured for a CORESET/SS, the CORESET/SS is type Y;
   It should be noted that RNTIs are used to differentiate/identify DCI format in addition to identifying which UE is being allocated;
   As further explanation, the UE can monitor DCI associated with more than one type of RNTI. A UE may monitor DCI associated with Cell-RNTI (C-RNTI) for UE-specific allocations. It may also monitor DCI associated with SFI-RNTI or CI-RNTI for some group-specific reasons (slot format indication and cancellation indication in these examples). If a CORESET is associated with SFI-RNTI or CI-RNTI, according to this arrangement, the UE should apply Type Y functionality (e.g. the gNB would want the UE to monitor for cancellation indications regardless of whether it was transmitting UE-specific data on PUSCH or not). If a CORESET is associated with C-RNTI, the UE would apply Type X functionality (the UE does not need to monitor PDCCH for further DL/UL grants when it is transmitting PUSCH).

Another way of describing the above functionality for the case of explicit RRC signaling is that there is a bit/IE (information element) in the RRC signalling and that bit/IE labels the CORESET as being Type X or Type Y. If the CORESET has Type X functionality, then PUSCH is prioritised over PDCCH. If the CORESET has type Y functionality, then the UE prioritises PDCCH over PUSCH.

In another arrangement of embodiments of the present disclosure, if the UE is scheduled an UL transmission that overlaps with DL measurement Reference Signals (RS), such as CSI-RS or other measurements signals used for beam failure recovery (BFR), the UE ignores these RS and transmits the UL transmission. It should be noted that the term “DL measurement reference signal” is not to be confused with the term “demodulation reference signal”. In other words, the characteristic of the downlink signal is whether or not the downlink signal comprises one or more measurement reference signals.

In another arrangement of embodiments of the present disclosure, the UE with an UL transmission that overlaps with DL measurement RS, such as CSI-RS, can switch to the DL to perform measurements using measurement gaps (in one example, these measurement gaps are distinct from the measurement gaps that are used for RRM measurements, e.g. to decide whether the UE should handover to another cell). These measurement gaps may be gaps created during the UL transmission. In other words, when the downlink signal comprises one or more measurement reference signals, the communications device may be configured to postpone or puncture transmission of the uplink signal during each of one or more measurement gaps inserted in the uplink signal, and, while the transmission of the uplink signal is postponed or punctured, to receive at least one of the measurement reference signals and to perform measurements using the at least one of the measurement reference signals.

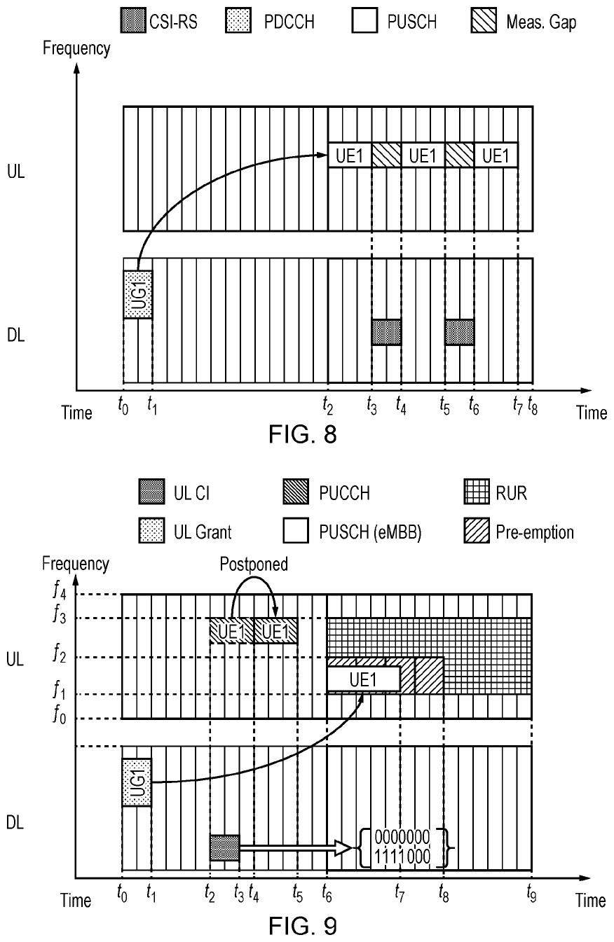

An example is shown in FIG. 8, where UE1 receives an Uplink Grant UG1 scheduling a PUSCH to transmit between time t₂ to t₇. The PUSCH overlaps with CSI-RS and here the UE punctures the PUSCH to create measurement gaps according to at least one of the following two methods:
Segmentation: The segmentation can follow the procedure used for Rel-16 eURLLC, enhanced Type B PUSCH (a more detailed explanation of PUSCH segmentation is provided by co-pending European patent application number EP20167439.7 [5], the contents of which are hereby incorporated by reference), where the symbols overlapping the measurements gaps are punctured and each segment would contain at least one demodulation reference signal (DMRS); or
Brute force puncturing: The UE punctures the PUSCH by not transmitting PUSCH symbols that overlap with the measurement gap.

Those skilled in the art would appreciate that the measurement gaps do not need to be created for every CSI-RS, they only need to be created for some of them.

In some implementations of this arrangement, these measurement gaps may be indicated by the gNB in the DCI. In other implementations of this arrangement, these measurement gaps may be RRC configured by the gNB.

In an arrangement of embodiments of the present disclosure, the gNB may allocate a lower coding rate to a PUSCH that overlaps with CSI-RS, since the UE may puncture PUSCH OFDM symbols that overlap with CSI-RS. In other words, the infrastructure equipment is configured to allocate a first coding rate to the communications device for the transmission of the uplink signal, the first coding rate being lower than a second coding rate that the infrastructure equipment would be configured to allocate to the communications device for the transmission of the uplink signal if the downlink signal did not comprise the one or more measurement reference signals.

In other related arrangements, the UE independently determines whether it will puncture PUSCH and measure CSI-RS or not. Here:
If the UE punctures and the gNB does not know about this, the gNB may decode the PUSCH and accept the performance impact of decoding the punctured PUSCH;
The gNB can perform two decoding attempts on the received PUSCH (blind decoding). In a first attempt, the gNB can assume no puncturing and in a second attempt, the gNB can assume that the UE punctured PUSCH that overlap with CSI-RS. If the gNB decodes correctly at the first attempt, there is no need to make the second attempt;
If the gNB at a later time receives a CSI report related to a CSI-RS that overlapped a PUSCH transmission, the gNB may re-decode the PUSCH on the assumption that CSI-RS punctured the PUSCH transmission.

If the UE does not measure CSI-RS, i.e. in order to transmit a PUSCH instead, a subsequent CSI report from the UE can indicate this to the gNB (e.g. a field or value within the CSI report can indicate “UE did not measure CSI due to PUSCH overlap”). The gNB can then ignore the CSI report.

Some arrangements of embodiments of the present disclosure, described below, are applicable to all collision cases of an UL transmission with a DL control signal, regardless of whether this DL control signal is a unicast DCI, a Group Common DCI (e.g. indicating an UL CI), CSI-RS, etc.

In an arrangement of embodiments of the present disclosure, the UE cancels its UL transmission if it needs to switch to the DL to monitor or receive a DL control signal that overlaps with its UL transmission. In other words, if the communications device is configured to receive the downlink signal in the set of downlink resources and to not transmit the uplink signal in the set of uplink resources, the communications device is configured to cancel the transmission of the uplink signal. For example in FIG. 6, UE1 will cancel its Pt PUSCH repetition since it needs to switch to the DL to monitor the overlapping UL CI.

In another arrangement of embodiments of the present disclosure, the UE postpones its UL transmission if it needs to switch to the DL to monitor or receive a DL control signal that overlaps with its UL transmission. In other words, if the communications device is configured to receive the downlink signal in the set of downlink resources and to not transmit the uplink signal in the set of uplink resources, the communications device is configured to postpone the transmission of the uplink signal and to instead transmit the uplink signal in a second set of uplink resources of the wireless communications network that is later in time than, or partially overlapped with and partly later in time than, the set of uplink resources of a wireless access interface in which the communications device was to have transmitted the uplink signal. Where the UL signal has been punctured or segmented, the postponement may apply to one or more parts of the UL signal. For example, whilst a first part of the UL signal (before the punctured symbols) may be transmitted as initially scheduled, a second part of the UL signal (after the punctured symbols) may be postponed and instead transmitted a number of symbols later than initially scheduled.

An example of this is shown in FIG. 9, where UE1 is scheduled a PUSCH in the RUR of an UL CI. The UE is also scheduled to transmit a PUCCH (e.g. carrying HARQ-ACK for an earlier PDSCH) at time t₂ to t₄, which collides with the UL CI and so the UE needs to switch to DL to monitor the UL CI. Here, the UE postpones the transmission of the PUCCH after it has received the UL CI. The time delay in which the UE transmits the postponed UL transmission can be:
Right after the DL control signal;
In the next available resource (in the example in FIG. 9, this will be the next PUCCH resource in the slot); or
A pre-determined time after the DL control signal.

In some arrangements of embodiments of the present disclosure, for an HD-FDD Type A UE, anything in the DL that needs monitoring may cause the puncturing of an UL transmission. The gNB knows when the UE is going to puncture and can hence choose an appropriate MCS for the UL transmission. Here:
If what the UE monitors in the DL is a small fraction of what the UE transmits in the UL, the UE monitors the DL transmission (by puncturing the UL transmission). The fraction could be signalled as some sort of threshold; and
Otherwise, if what the UE monitors in the DL is not a small fraction of what the UE transmits in the UL, the UE postpones any part of a PUSCH that overlaps with a DL control signal.

In some embodiments of the present disclosure, the UE can be configured to either operate in accordance with any of the arrangements as described herein, or alternatively to always monitor the DL control signal, i.e. whenever there is a collision the UE always switches to the DL and monitors the DL control signal. In other words, the characteristic of the downlink signal and the characteristic of the uplink signal are simply each that the set of uplink resources at least partially overlaps in time with the set of downlink resources, and if the set of uplink resources at least partially overlaps in time with the set of downlink resources, the communications device is configured to receive the downlink signal in the set of downlink resources and to not transmit the uplink signal in the set of uplink resources.

In an implementation of such embodiments of the present technique, the type of DL control signal that the UE should always monitor can be selected, i.e. the UE can be configured to always monitor SFI but follow the above embodiments for UL CI. In other words, the characteristic of the downlink signal is which type of a plurality of types the downlink signal is.

In another arrangement of embodiments of the present disclosure, the gNB can configure for which DCI Formats the UE needs to switch to the DL to monitor if there is an UL transmission overlapping the Search Space for that DCI Format. For example, the gNB can configure that a UE transmitting PUSCH (1) does not switch to the DL to monitor DCI format 1_0, but (2) does switch to the DL to monitor DCI format 1_2. In other words, the characteristic of the downlink signal is which format of a plurality of formats the downlink signal is. This may be useful for a DCI Format (e.g. DCI format 1_2) that may be associated with High L1 priority scheduling.

In another arrangement of embodiments of the present disclosure, regardless of the type of DL control signal, the UE can be configured to not switch to the DL to monitor a DL control signal if the UL transmission has High L1 priority. In some implementations of such an arrangement, this configuration may cause the UE to override other configurations, such as that shown in FIG. 6. For example, even if the UL signal collides with a UL-CI and is configured with Behaviour 2, according to this arrangement, the UE does not switch to the DL to monitor the UL-CI.

### Flow Chart Representation

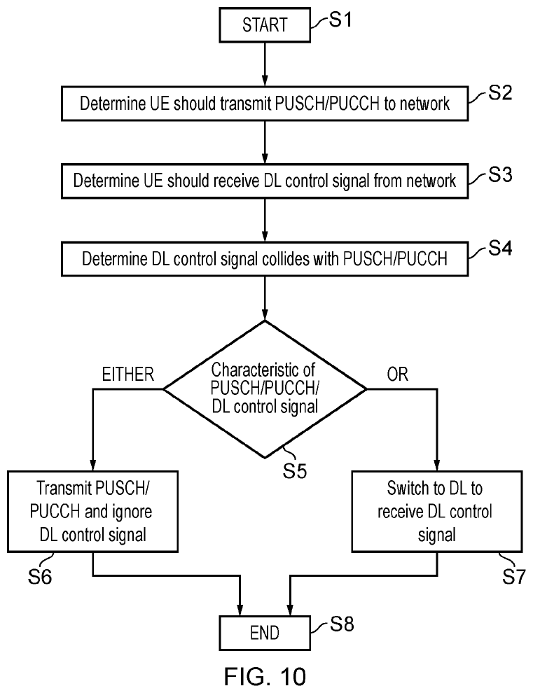

FIG. 10 shows a flow diagram illustrating an example process of communications in a communications system in accordance with embodiments of the present technique. The process shown by FIG. 10 is a method of operating an HD-FDD communications device (which may be configured to transmit data to or receive data from an infrastructure equipment) in a wireless communications network.

The method begins in step S1. The method comprises, in step S2, determining that the communications device is to transmit an uplink signal comprising at least one of data and control information to the wireless communications network in a set of uplink resources of a wireless access interface. The process then moves to step S3, which involves determining that the communications device is to receive a downlink control signal from the wireless communications network in a set of downlink resources of the wireless access interface. Next, in step S4, the method comprises determining that the set of uplink resources at least partially overlaps in time with the set of downlink resources. The process then comprises, in step S5, detecting a characteristic of the uplink signal and/or a characteristic of the downlink signal. Then, depending on the characteristic of the uplink signal and/or the characteristic of the downlink signal, the method comprises either, in step S6, transmitting the uplink signal in the set of uplink resources and not receiving (i.e. ignoring) the downlink signal in the set of downlink resources or, in step S7, receiving the downlink signal in the set of downlink resources and not transmitting (i.e. cancelling or postponing transmission of) the uplink signal in the set of uplink resources. Here, a characteristic of the resources of the selected one or more repetitions of the second uplink signal satisfies a predetermined condition. The method ends in step S8.

Those skilled in the art would appreciate that the method shown by FIG. 10 may be adapted in accordance with embodiments of the present technique. For example, other intermediate steps may be included in the method, or the steps may be performed in any logical order.

Though embodiments of the present technique have been described largely by way of the example communications system shown in FIG. 5, and further with respect to FIGS. 6 to 9, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device in a wireless communications network, the communications device operating in accordance with a Half Duplex Frequency Division Duplex, HD-FDD, mode of operation, the method comprising

determining that the communications device is to transmit an uplink signal comprising at least one of data and control information to the wireless communications network in a set of uplink resources of a wireless access interface,

determining that the communications device is to receive a downlink control signal from the wireless communications network in a set of downlink resources of the wireless access interface,

determining that the set of uplink resources at least partially overlaps in time with the set of downlink resources, and, depending on a characteristic of the uplink signal and/or a characteristic of the downlink signal, either

transmitting the uplink signal in the set of uplink resources and not receiving the downlink signal in the set of downlink resources, or

receiving the downlink signal in the set of downlink resources and not transmitting the uplink signal in the set of uplink resources.
Paragraph 2. A method according to Paragraph 1, wherein the downlink signal is an uplink cancellation indicator, UL-CI, the UL-CI being associated with a reference uplink region, RUR, and indicating a second set of uplink resources of the wireless access interface within the RUR,

wherein, if so indicated by the UL-CI and if the communications device is configured to monitor the UL CI, the method comprises cancelling any scheduled uplink transmissions which overlap with the second set of uplink resources.
Paragraph 3. A method according to Paragraph 2, wherein the characteristic of the uplink signal is a priority level of a plurality of priority levels associated with the uplink signal.
Paragraph 4. A method according to Paragraph 2 or Paragraph 3, wherein the characteristic of the uplink signal is whether or not the set of uplink resources at least partially overlaps in both time and frequency with the uplink resources defined by the RUR.
Paragraph 5. A method according to any of Paragraphs 2 to 4, wherein the characteristic of the uplink signal is whether or not a third set of uplink resources within which the communications device is to transmit a second uplink signal at least partially overlaps in both time and frequency with the uplink resources defined by the RUR.
Paragraph 6. A method according to any of Paragraphs 1 to 5, wherein the downlink signal is a slot format indicator, SFI, defining a format for one or more symbols of the wireless communications interface, and

wherein the characteristic of the uplink signal is whether or not the uplink signal is an enhanced Type B Physical Uplink Shared Channel, PUSCH, scheduled dynamically by the wireless communications network.
Paragraph 7. A method according to any of Paragraphs 1 to 6, wherein the set of downlink resources is one of a control resource set, CORESET, and a search space, SS, in which the communications device is configured to receive control information from the wireless communications network, and

wherein the characteristic of the downlink signal is which type of a plurality of types the CORESET and/or SS is.
Paragraph 8. A method according to Paragraph 7, comprising

determining the type of the CORESET and/or SS via Radio Resource Control, RRC, signalling indicated by the wireless communications network.
Paragraph 9. A method according to Paragraph 7 or Paragraph 8, comprising

determining the type of the CORESET and/or SS based on an identifier of the CORESET and/or SS, the identifier indicating the type of the CORESET and/or SS.
Paragraph 10. A method according to any of Paragraphs 7 to 9, comprising

determining the type of the CORESET and/or SS based on a Radio Network Temporary Identifier, RNTI, to be used by the communications device for downlink control signal monitoring.
Paragraph 11. A method according to any of Paragraphs 1 to 10, wherein the characteristic of the downlink signal is whether or not the downlink signal comprises one or more measurement reference signals.
Paragraph 12. A method according to Paragraph 11, comprising, when the downlink signal comprises one or more measurement reference signals

postponing transmission of the uplink signal during each of one or more measurement gaps inserted in the uplink signal, and, while the transmission of the uplink signal is postponed,

receiving at least one of the measurement reference signals and performing measurements using the at least one of the measurement reference signals.
Paragraph 13. A method according to Paragraph 12, comprising

receiving an indication of locations within the uplink signal of the one or more measurement gaps from the wireless communications network via downlink control information.
Paragraph 14. A method according to Paragraph 12 or Paragraph 13, comprising receiving an indication of locations within the uplink signal of the one or more measurement gaps from the wireless communications network via RRC signalling.
Paragraph 15. A method according to any of Paragraphs 12 to 14, comprising

inserting the one or more measurement gaps by puncturing one or more symbols of the uplink signal which overlap each of the measurement gaps.
Paragraph 16. A method according to any of Paragraphs 12 to 15, comprising

inserting the one or more measurement gaps by not transmitting each of one or more symbols of the uplink signal which overlap each of the measurement gaps.
Paragraph 17. A method according to any of Paragraphs 1 to 16, wherein when the method comprises receiving the downlink signal in the set of downlink resources and not transmitting the uplink signal in the set of uplink resources, the method further comprises

cancelling the transmission of the uplink signal.
Paragraph 18. A method according to any of Paragraphs 1 to 17, wherein when the method comprises receiving the downlink signal in the set of downlink resources and not transmitting the uplink signal in the set of uplink resources, the method further comprises

postponing the transmission of the uplink signal and instead transmitting the uplink signal in a second set of uplink resources of the wireless communications network that is later in time than the set of uplink resources of a wireless access interface in which the communications device was to have transmitted the uplink signal.
Paragraph 19. A method according to any of Paragraphs 1 to 18, wherein the characteristic of the downlink signal is which type of a plurality of types the downlink signal is.
Paragraph 20. A method according to any of Paragraphs 1 to 19, wherein the characteristic of the downlink signal is which format of a plurality of formats the downlink signal is.
Paragraph 21. A method according to any of Paragraphs 1 to 20, wherein the characteristic of the downlink signal and the characteristic of the uplink signal are each that the set of uplink resources at least partially overlaps in time with the set of downlink resources, and if the set of uplink resources at least partially overlaps in time with the set of downlink resources, the method comprises

receiving the downlink signal in the set of downlink resources and not transmitting the uplink signal in the set of uplink resources.
Paragraph 22. A method of operating a communications device in a wireless communications network, the communications device operating in accordance with a Half Duplex Frequency Division Duplex, HD-FDD, mode of operation, the method comprising

determining that the communications device is to transmit an uplink signal comprising at least one of data and control information to the wireless communications network in a set of uplink resources of a wireless access interface,

determining that the communications device is to receive a downlink control signal from the wireless communications network in a set of downlink resources of the wireless access interface,

determining that the set of uplink resources at least partially overlaps in time with the set of downlink resources, and

receiving the downlink signal in the set of downlink resources and not transmitting the uplink signal in the set of uplink resources.
Paragraph 23. A communications device suitable for use in a wireless communications network, the communications device operating in accordance with a Half Duplex Frequency Division Duplex, HD-FDD, mode of operation, and comprising

transceiver circuitry configured to transmit signals and receive signals via a wireless access interface, and

controller circuitry configured in combination with the transceiver circuitry

to determine that the communications device is to transmit an uplink signal comprising at least one of data and control information to the wireless communications network in a set of uplink resources of a wireless access interface,

to determine that the communications device is to receive a downlink control signal from the wireless communications network in a set of downlink resources of the wireless access interface,

to determine that the set of uplink resources at least partially overlaps in time with the set of downlink resources, and, depending on a characteristic of the uplink signal and/or a characteristic of the downlink signal, either

to transmit the uplink signal in the set of uplink resources and to not receive the downlink signal in the set of downlink resources, or

to receive the downlink signal in the set of downlink resources and to not transmit the uplink signal in the set of uplink resources.
Paragraph 24. Circuitry for a communications device suitable for use in a wireless communications network, the communications device operating in accordance with a Half Duplex Frequency Division Duplex, HD-FDD, mode of operation, the circuitry comprising

transceiver circuitry configured to transmit signals and receive signals via a wireless access interface, and

controller circuitry configured in combination with the transceiver circuitry

to determine that the communications device is to transmit an uplink signal comprising at least one of data and control information to the wireless communications network in a set of uplink resources of a wireless access interface,

to determine that the communications device is to receive a downlink control signal from the wireless communications network in a set of downlink resources of the wireless access interface,

to determine that the set of uplink resources at least partially overlaps in time with the set of downlink resources, and, depending on a characteristic of the uplink signal and/or a characteristic of the downlink signal, either

to transmit the uplink signal in the set of uplink resources and to not receive the downlink signal in the set of downlink resources, or

to receive the downlink signal in the set of downlink resources and to not transmit the uplink signal in the set of uplink resources.
Paragraph 25. A method of operating an infrastructure equipment forming part of a wireless communications network configured to transmit signals to and/or to receive signals from a communications device operating in accordance with a Half Duplex Frequency Division Duplex, HD-FDD, mode of operation, the method comprising

determining that the infrastructure equipment is to receive an uplink signal comprising at least one of data and control information from the communications device in a set of uplink resources of a wireless access interface,

determining that the infrastructure equipment is to transmit a downlink control signal to the communications device in a set of downlink resources of the wireless access interface,

determining that the set of uplink resources at least partially overlaps in time with the set of downlink resources, and, depending on a characteristic of the uplink signal and/or a characteristic of the downlink signal, determining either

that the infrastructure equipment will receive the uplink signal from the communications device in the set of uplink resources and that the downlink signal will not be received by the communications device in the set of downlink resources, or

that the downlink signal will be received by the communications device in the set of downlink resources and that the infrastructure equipment will not receive the uplink signal from the communications device in the set of uplink resources.
Paragraph 26. A method according to Paragraph 25, wherein the downlink signal is an uplink cancellation indicator, UL-CI, the UL-CI being associated with a reference uplink region, RUR, and indicating a second set of uplink resources of the wireless access interface within the RUR,

wherein, if so indicated by the UL-CI and if the communications device is configured to monitor for the UL-CI, the method comprises cancelling any scheduled uplink transmissions which overlap with the second set of uplink resources.
Paragraph 27. A method according to Paragraph 26, wherein the characteristic of the uplink signal is a priority level of a plurality of priority levels associated with the uplink signal.
Paragraph 28. A method according to Paragraph 26 or Paragraph 27, wherein the characteristic of the uplink signal is whether or not the set of uplink resources at least partially overlaps in both time and frequency with the uplink resources defined by the RUR.
Paragraph 29. A method according to any of Paragraphs 26 to 28, wherein the characteristic of the uplink signal is whether or not a third set of uplink resources within which the communications device is to transmit a second uplink signal at least partially overlaps in both time and frequency with the uplink resources defined by the RUR.
Paragraph 30. A method according to any of Paragraphs 25 to 29, wherein the downlink signal is a slot format indicator, SFI, defining a format for one or more symbols of the wireless communications interface, and

wherein the characteristic of the uplink signal is whether or not the uplink signal is an enhanced Type B Physical Uplink Shared Channel, PUSCH, scheduled dynamically by the wireless communications network.
Paragraph 31. A method according to any of Paragraphs 25 to 30, wherein the set of downlink resources is one of a control resource set, CORESET, and a search space, SS, in which the wireless communications network is configured to transmit control information to the communications device, and

wherein the characteristic of the downlink signal is which type of a plurality of types the CORESET and/or SS is.
Paragraph 32. A method according to Paragraph 31, comprising

transmitting Radio Resource Control, RRC, signalling to the communications device, the RRC signalling indicating the type of the CORESET and/or SS.
Paragraph 33. A method according to Paragraph 31 or Paragraph 32, wherein

the type of the CORESET and/or SS is based on an identifier of the CORESET and/or SS, the identifier indicating the type of the CORESET and/or the SS.
Paragraph 34. A method according to any of Paragraphs 31 to 33, wherein

the type of the CORESET and/or SS is based on a Radio Network Temporary Identifier, RNTI, to be used by the communications device for downlink control signal monitoring.
Paragraph 35. A method according to any of Paragraphs 25 to 34, wherein the characteristic of the downlink signal is whether or not the downlink signal comprises one or more measurement reference signals.
Paragraph 36. A method according to Paragraph 35, comprising

transmitting an indication of locations within the uplink signal of one or more measurement gaps to the communications device via downlink control information, the measurement gaps being for insertion in the uplink signal by the communications device and during which the uplink signal may be postponed or punctured by the communications device while at least one of the measurement reference signals is received by the communications device and used by the communications device to perform measurements.
Paragraph 37. A method according to Paragraph 35 or Paragraph 36, comprising

transmitting an indication of locations within the uplink signal of the one or more measurement gaps to the communications device via RRC signalling, the measurement gaps being for insertion in the uplink signal by the communications device and during which the uplink signal may be postponed or punctured by the communications device while at least one of the measurement reference signals is received by the communications device and used by the communications device to perform measurements.
Paragraph 38. A method according to any of Paragraphs 35 to 37, comprising

allocating a first coding rate to the communications device for the transmission of the uplink signal, the first coding rate being lower than a second coding rate that the infrastructure equipment would be configured to allocate to the communications device for the transmission of the uplink signal if the downlink signal did not comprise the one or more measurement reference signals.
Paragraph 39. A method according to any of Paragraphs 25 to 38, wherein when the method comprises determining that the downlink signal will be received by the communications device in the set of downlink resources and that the infrastructure equipment will not receive the uplink signal from the communications device in the set of uplink resources, the method further comprises

determining that the communications device will cancel the transmission of the uplink signal.
Paragraph 40. A method according to any of Paragraphs 25 to 39, wherein when the method comprises determining that the downlink signal will be received by the communications device in the set of downlink resources and that the infrastructure equipment will not receive the uplink signal from the communications device in the set of uplink resources, the method further comprises

determining that the communications device will postpone the transmission of the uplink signal and that the infrastructure equipment will instead receive the uplink signal in a second set of uplink resources of the wireless communications network that is later in time than the set of uplink resources of a wireless access interface in which the infrastructure equipment was to have received the uplink signal.
Paragraph 41. A method according to any of Paragraphs 25 to 40, wherein the characteristic of the downlink signal is which type of a plurality of types the downlink signal is.
Paragraph 42. A method according to any of Paragraphs 25 to 41, wherein the characteristic of the downlink signal is which format of a plurality of formats the downlink signal is.
Paragraph 43. A method according to any of Paragraphs 25 to 42, wherein the characteristic of the downlink signal and the characteristic of the uplink signal are each that the set of uplink resources at least partially overlaps in time with the set of downlink resources, and if the set of uplink resources at least partially overlaps in time with the set of downlink resources, the method comprises

determining that the downlink signal will be received by the communications device in the set of downlink resources and that the infrastructure equipment will not receive the uplink signal from the communications device in the set of uplink resources.
Paragraph 44. An infrastructure equipment forming part of a wireless communications network, the infrastructure equipment configured to transmit signals to and/or to receive signals from a communications device operating in accordance with a Half Duplex Frequency Division Duplex, HD-FDD, mode of operation, the infrastructure equipment comprising

transceiver circuitry configured to transmit signals and receive signals via a wireless access interface provided by the infrastructure equipment, and

controller circuitry configured in combination with the transceiver circuitry

to determine that the infrastructure equipment is to receive an uplink signal comprising at least one of data and control information from the communications device in a set of uplink resources of a wireless access interface,

to determine that the infrastructure equipment is to transmit a downlink control signal to the communications device in a set of downlink resources of the wireless access interface,

to determine that the set of uplink resources at least partially overlaps in time with the set of downlink resources, and, depending on a characteristic of the uplink signal and/or a characteristic of the downlink signal, to determine either

that the infrastructure equipment will receive the uplink signal from the communications device in the set of uplink resources and that the downlink signal will not be received by the communications device in the set of downlink resources, or

that the downlink signal will be received by the communications device in the set of downlink resources and that the infrastructure equipment will not receive the uplink signal from the communications device in the set of uplink resources.
Paragraph 45. Circuitry for an infrastructure equipment forming part of a wireless communications network, the infrastructure equipment configured to transmit signals to and/or to receive signals from a communications device operating in accordance with a Half Duplex Frequency Division Duplex, HD-FDD, mode of operation, the circuitry comprising

transceiver circuitry configured to transmit signals and receive signals via a wireless access interface provided by the infrastructure equipment, and

controller circuitry configured in combination with the transceiver circuitry

to determine that the infrastructure equipment is to receive an uplink signal comprising at least one of data and control information from the communications device in a set of uplink resources of a wireless access interface,

to determine that the infrastructure equipment is to transmit a downlink control signal to the communications device in a set of downlink resources of the wireless access interface,

to determine that the set of uplink resources at least partially overlaps in time with the set of downlink resources, and, depending on a characteristic of the uplink signal and/or a characteristic of the downlink signal, to determine either

that the infrastructure equipment will receive the uplink signal from the communications device in the set of uplink resources and that the downlink signal will not be received by the communications device in the set of downlink resources, or

that the downlink signal will be received by the communications device in the set of downlink resources and that the infrastructure equipment will not receive the uplink signal from the communications device in the set of uplink resources.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LIE for UMTS OFDMA and SC-FDMA based radio access”, John Wiley and Sons, 2009.
[2] TR 38.913, “Study on Scenarios and Requirements for Next Generation Access Technologies (Release 14)”, 3^{rd} Generation Partnership Project, v14.3.0.
[3] RP-193238, “New SID on support of reduced capability NR devices,” Ericsson, 3GPP TSG RAN #86.
[4] European patent application number EP20167632.7.
[5] European patent application number EP20167439.7.

1. A method of operating a communications device in a wireless communications network, the communications device operating in accordance with a Half Duplex Frequency Division Duplex, HD-FDD, mode of operation, the method comprising
determining that the communications device is to transmit an uplink signal comprising at least one of data and control information to the wireless communications network in a set of uplink resources of a wireless access interface,
determining that the communications device is to receive a downlink control signal from the wireless communications network in a set of downlink resources of the wireless access interface,
determining that the set of uplink resources at least partially overlaps in time with the set of downlink resources, and, depending on a characteristic of the uplink signal and/or a characteristic of the downlink signal, either
transmitting the uplink signal in the set of uplink resources and not receiving the downlink signal in the set of downlink resources, or
receiving the downlink signal in the set of downlink resources and not transmitting the uplink signal in the set of uplink resources.

2. A method according to claim 1, wherein the downlink signal is an uplink cancellation indicator, UL-CI, the UL-CI being associated with a reference uplink region, RUR, and indicating a second set of uplink resources of the wireless access interface within the RUR,
wherein, if so indicated by the UL-CI and if the communications device is configured to monitor the UL CI, the method comprises cancelling any scheduled uplink transmissions which overlap with the second set of uplink resources.

3. A method according to claim 2, wherein the characteristic of the uplink signal is a priority level of a plurality of priority levels associated with the uplink signal.

4. A method according to claim 2, wherein the characteristic of the uplink signal is whether or not the set of uplink resources at least partially overlaps in both time and frequency with the uplink resources defined by the RUR.

5. A method according to claim 2, wherein the characteristic of the uplink signal is whether or not a third set of uplink resources within which the communications device is to transmit a second uplink signal at least partially overlaps in both time and frequency with the uplink resources defined by the RUR.

6. A method according to claim 1, wherein the downlink signal is a slot format indicator, SFI, defining a format for one or more symbols of the wireless communications interface, and
wherein the characteristic of the uplink signal is whether or not the uplink signal is an enhanced Type B Physical Uplink Shared Channel, PUSCH, scheduled dynamically by the wireless communications network.

7. A method according to claim 1, wherein the set of downlink resources is one of a control resource set, CORESET, and a search space, SS, in which the communications device is configured to receive control information from the wireless communications network, and
wherein the characteristic of the downlink signal is which type of a plurality of types the CORESET and/or SS is.

8. A method according to claim 7, comprising
determining the type of the CORESET and/or SS via Radio Resource Control, RRC, signalling indicated by the wireless communications network.

9. A method according to claim 7, comprising
determining the type of the CORESET and/or SS based on an identifier of the CORESET and/or SS, the identifier indicating the type of the CORESET and/or SS.

10. A method according to claim 7, comprising
determining the type of the CORESET and/or SS based on a Radio Network Temporary Identifier, RNTI, to be used by the communications device for downlink control signal monitoring.

11. A method according to claim 1, wherein the characteristic of the downlink signal is whether or not the downlink signal comprises one or more measurement reference signals.

12. A method according to claim 11, comprising, when the downlink signal comprises one or more measurement reference signals
postponing transmission of the uplink signal during each of one or more measurement gaps inserted in the uplink signal, and, while the transmission of the uplink signal is postponed,
receiving at least one of the measurement reference signals and performing measurements using the at least one of the measurement reference signals.

13. A method according to claim 12, comprising
receiving an indication of locations within the uplink signal of the one or more measurement gaps from the wireless communications network via downlink control information.

14. A method according to claim 12, comprising
receiving an indication of locations within the uplink signal of the one or more measurement gaps from the wireless communications network via RRC signalling.

15. A method according to claim 12, comprising
inserting the one or more measurement gaps by puncturing one or more symbols of the uplink signal which overlap each of the measurement gaps.

16. A method according to claim 12, comprising
inserting the one or more measurement gaps by not transmitting each of one or more symbols of the uplink signal which overlap each of the measurement gaps.

17. A method according to claim 1, wherein when the method comprises receiving the downlink signal in the set of downlink resources and not transmitting the uplink signal in the set of uplink resources, the method further comprises
cancelling the transmission of the uplink signal.

18. A method according to claim 1, wherein when the method comprises receiving the downlink signal in the set of downlink resources and not transmitting the uplink signal in the set of uplink resources, the method further comprises
postponing the transmission of the uplink signal and instead transmitting the uplink signal in a second set of uplink resources of the wireless communications network that is later in time than the set of uplink resources of a wireless access interface in which the communications device was to have transmitted the uplink signal.

19.-21. (canceled)

22. A method of operating a communications device in a wireless communications network, the communications device operating in accordance with a Half Duplex Frequency Division Duplex, HD-FDD, mode of operation, the method comprising
determining that the communications device is to transmit an uplink signal comprising at least one of data and control information to the wireless communications network in a set of uplink resources of a wireless access interface,
determining that the communications device is to receive a downlink control signal from the wireless communications network in a set of downlink resources of the wireless access interface,
determining that the set of uplink resources at least partially overlaps in time with the set of downlink resources, and
receiving the downlink signal in the set of downlink resources and not transmitting the uplink signal in the set of uplink resources.

23.-43. (canceled)

44. An infrastructure equipment forming part of a wireless communications network, the infrastructure equipment configured to transmit signals to and/or to receive signals from a communications device operating in accordance with a Half Duplex Frequency Division Duplex, HD-FDD, mode of operation, the infrastructure equipment comprising
transceiver circuitry configured to transmit signals and receive signals via a wireless access interface provided by the infrastructure equipment, and
controller circuitry configured in combination with the transceiver circuitry
to determine that the infrastructure equipment is to receive an uplink signal comprising at least one of data and control information from the communications device in a set of uplink resources of a wireless access interface,
to determine that the infrastructure equipment is to transmit a downlink control signal to the communications device in a set of downlink resources of the wireless access interface,
to determine that the set of uplink resources at least partially overlaps in time with the set of downlink resources, and, depending on a characteristic of the uplink signal and/or a characteristic of the downlink signal, to determine either
that the infrastructure equipment will receive the uplink signal from the communications device in the set of uplink resources and that the downlink signal will not be received by the communications device in the set of downlink resources, or
that the downlink signal will be received by the communications device in the set of downlink resources and that the infrastructure equipment will not receive the uplink signal from the communications device in the set of uplink resources.

45. (canceled)
